(19) United States
(12) Patent Application Publication
(10) Pub. No.: US 2026/0316664 A1
(43) Pub. Date: Oct. 15, 2026

(54) DRIVER ASSISTANT APPARATUS, VEHICLE, AND DRIVER ASSISTANCE METHOD

(71) Applicant: SUBARU CORPORATION, Tokyo (JP)

(72) Inventor: Fumiya SATO, Tokyo (JP)

(21) Appl. No.: 19/104,165

(22) PCT Filed: Sep. 7, 2023
(86) PCT No.: PCT/JP2023/032648

§ 371 Date: Feb. 14, 2025

(51) Int. Cl. B60Q 1/02

(52) U.S. Cl. CPC B60Q 1/02; B60Q 2300/32

(57) ABSTRACT

A driver assistant apparatus according to an aspect of the disclosure includes a controller configured to provide driver assistance. The controller is configured to: derive, based on a position of a road surface shape estimation sign disposed at a position away from a road surface of a roadway, a casting position on the road surface, in which the position of the road surface shape estimation sign is detected by a sensor; and control casting of visible laser light based on the derived casting position.

### TECHNICAL FIELD

The disclosure relates to a driver assistant apparatus to be mounted on a vehicle and a vehicle including such a driver assistant apparatus, and a driver assistance method to be carried out in such a driver assistant apparatus.

### BACKGROUND ART

In snowy areas, a snowstorm or the like causes poor visibility (e.g., white out, etc.), and a driver sometimes has difficulties in accurately grasping a shape of a roadway (travel lane). In such a case, there is possibility that, for example, the driver deviates from the roadway (travel lane) or falls into a groove provided on a road edge of the roadway (travel lane). For example, in Patent Literatures 1 and 2, proposals have been made for techniques that allows for safe driving even in a snowstorm.

### CITATION LIST

### Patent Literature

Patent Literature 1: Japanese Unexamined Patent Application Publication No. 2022-53409
Patent Literature 2; Japanese Unexamined Patent Application Publication No. 2010-221909

### SUMMARY OF INVENTION

A driver assistant apparatus according to an aspect of the disclosure includes a controller configured to provide driver assistance. The controller is configured to: derive, based on a position of a road surface shape estimation sign disposed at a position away from a road surface of a roadway, a casting position on the road surface, in which the position of the road surface shape estimation sign is detected by a sensor; and control casting of visible laser light based on the derived casting position.

A vehicle according to an aspect of the disclosure includes a controller configured to provide driver assistance. The controller is configured to: derive, based on a position of a road surface shape estimation sign disposed at a position away from a road surface of a roadway, a casting position on the road surface, in which the position of the road surface shape estimation sign is detected by a sensor; and control casting of visible laser light based on the derived casting position.

A driver assistance method according to an aspect of the disclosure includes the following three:
(A) deriving, based on a position of a road surface shape estimation sign disposed at a position away from a road surface, a casting position on the road surface, in which the position of the road surface shape estimation sign is detected by a sensor; and
(B) casting visible laser light based on the derived casting position.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a view illustrating an example of an appearance of a front part of a vehicle including a driver assistant apparatus according to an embodiment of the disclosure.

FIG. 2 is a view illustrating another example of the appearance of the front part of the vehicle in FIG. 1.

FIG. 3 is a view illustrating an example of scenery frontward of the vehicle as viewed frontward from a driver's seat.

FIG. 4 is a view illustrating an example of a state in which a snowstorm or the like has caused poor visibility.

FIG. 5 is a view illustrating an example of a state in which the vehicle in FIG. 1 casts a linear visible laser pattern on a road edge of a roadway (travel lane) estimated based on a position of an arrow blade.

FIG. 6 is a view illustrating an example of a state in which the vehicle in FIG. 1 casts the linear visible laser pattern on the road edge and near a centerline of the roadway (travel lane) estimated based on the position of the arrow blade.

FIG. 7 is a view illustrating an example of a state in which the vehicle in FIG. 1 casts a curved visible laser pattern on the road edge of the roadway (travel lane) estimated based on the position of the arrow blade.

FIG. 8 is a view illustrating an example of a state in which the vehicle in FIG. 1 casts a wide visible laser pattern on the road edge of the roadway (travel lane) estimated based on the position of the arrow blade.

FIG. 9 is a view illustrating an example of a state in which the vehicle in FIG. 1 casts a mesh-shaped visible laser pattern on the road edge of the roadway (travel lane) estimated based on the position of the arrow blade.

FIG. 10 is a diagram illustrating a functional block example of a travel controller to be mounted on the vehicle in FIG. 1.

FIG. 11 is a diagram for description of a calculation method of a casting position of a visible laser pattern.

FIG. 12 is a diagram for description of an example of a procedure of casting the visible laser pattern in the travel controller in FIG. 10.

FIG. 13 is a diagram illustrating an example of a state in which the vehicle in FIG. 1 casts the linear visible laser pattern on the road edge of the roadway (travel lane) estimated based on a position of a snow pole.

FIG. 14 is a diagram for description of the calculation method of the casting position of the visible laser pattern.

### MODES FOR CARRYING OUT THE INVENTION

In the following, some embodiments of the disclosure are described in detail with reference to the drawings.

### 1. Background

In snowy areas, a snowstorm or the like causes poor visibility (e.g., white out, etc.), and a driver sometimes has difficulties in accurately grasping a shape of a roadway (travel lane). In such a case, there is possibility that, for example, a vehicle deviates from the roadway (travel lane) or falls into a groove provided on a road edge of the roadway (travel lane). For example, in Patent Literatures 1 and 2, etc., proposals have been made for techniques that allows for safe driving even in a snowstorm.

In the invention described in Patent Literature 1, traffic safety facilities including a guardrail and lane lines are detected by microwave radar, and an image (laser image) including the traffic safety facilities is projected at the detected position on a road surface, a snow surface, etc. frontward of the vehicle. However, in the invention described in Patent Literature 1, it is not possible to cope with traffic safety facilities that are difficult to detect by microwave radar. Moreover, in the invention described in Patent Literature 1, the laser image including the traffic safety facilities is projected on a place of the detected traffic safety facilities. Accordingly, even when the laser image is casted on a sign indirectly indicating a road edge of a roadway (travel lane), e.g., an arrow blade or a snow pole, it is impossible for the driver to directly know the road edge of the roadway (travel lane). Thus, in the invention described in Patent Literature 1, there is possibility that, for example, the vehicle deviates from the roadway (travel lane) or falls into a groove provided on the road edge of the roadway (travel lane).

In the invention described in Patent Literature 2, a position of an arrow blade is detected by using a stereo camera, and a road shape is estimated based on a detection result. As a result, it is possible to make a travel control based on the estimated road shape and to give warning of a risk. However, the invention described in Patent Literature 2 assumes that the travel control is made automatically. Accordingly, there is possibility that, for example, the vehicle deviates from the roadway (travel lane) or falls into a groove provided on the road edge of the roadway (travel lane) during manual driving.

As described, so far, there have been a concern that it is not possible to cope with safe driving in a snowstorm during manual driving. Thus, as a result of intensive studies by the inventors of the application, it is desirable to provide a driver assistant apparatus that makes it possible to drive safely in a snowstorm during manual driving, a vehicle including such a driver assistant knowledge, and a driver assistance method to be carried out in such a driver assistant apparatus.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 2. Embodiment

### Configuration

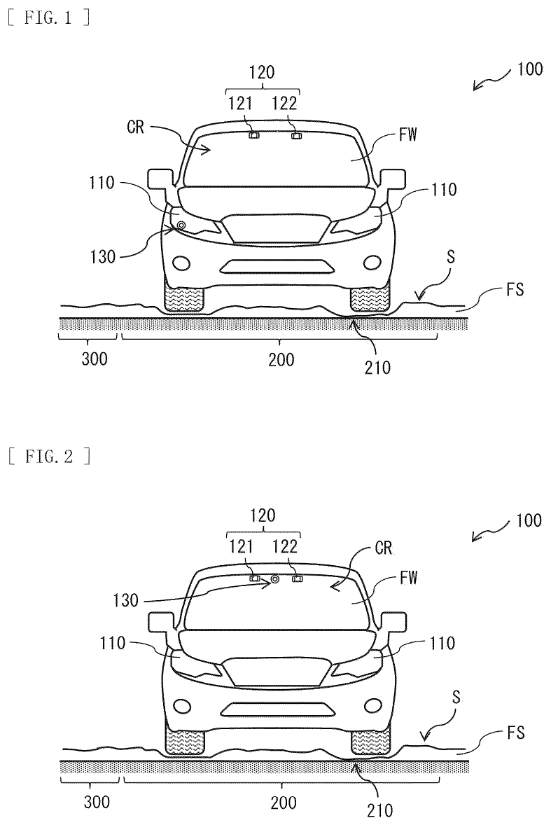

FIG. 1 illustrates an example of an appearance of a front part of a vehicle 100 according to an embodiment of the disclosure. There is no particular limitation on a driving method of the vehicle 100. For example, the vehicle 100 is configured to travel by driving one or both of an engine and a motor. As illustrated in FIG. 1, for example, the vehicle 100 includes a pair of right and left headlights 110 and a front windshield FW in the front part. Inside the headlights 110, a laser irradiator 130 is provided. Inside a cabin CR that is visible from outside through the front windshield FW, a stereo camera 120 is provided. The stereo camera 120 includes a main camera 121 and a sub-camera 122. There is no particular limitation on a position of the laser irradiator 130 as long as the laser irradiator 130 is in the front part of the vehicle 100. The laser irradiator 130 may be provided in the cabin CR, for example, as illustrated in FIG. 2.

FIGS. 1 and 2 illustrate, as an example, a state in which the vehicle 100 is traveling on a roadway (travel lane) 200 in a snowy area. A non-roadway 300 is provided beside the roadway 200. The non-roadway 300 includes, for example, a roadside, a road shoulder, or a sidewalk. A surface (travel road surface 210) of the roadway 200 is covered with snow accumulation FS. In the snow accumulation FS, for example, a rut or the like is formed. Accordingly, in the surface (snow surface S) of the snow accumulation FS, various unevenness is formed by the rut or the like.

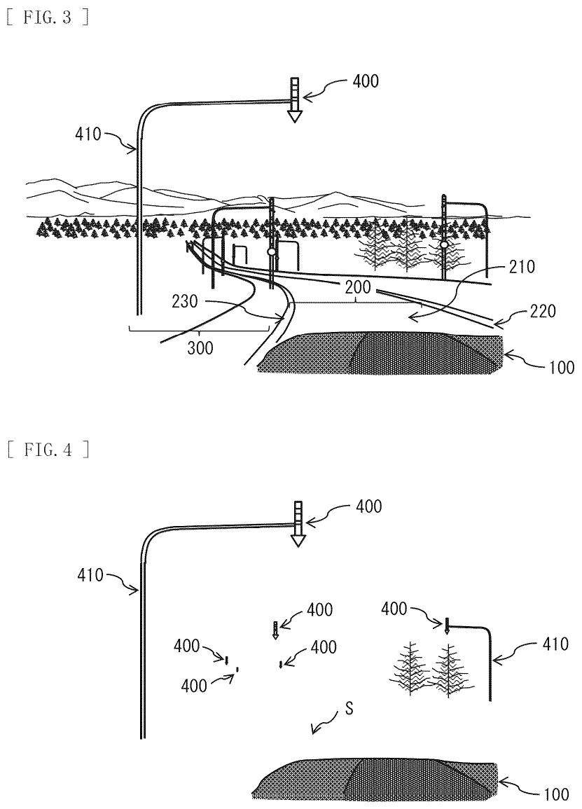

FIG. 3 illustrates a view of an example of scenery frontward of the vehicle when the driver looks frontward of the vehicle from the driver's seat while the vehicle 100 is traveling on the roadway 200 covered with the snow accumulation FS. In FIG. 3, the snow accumulation FS is omitted for convenience of explanation. The roadway 200 is in adjacency to the non-roadway 300. Within the roadway 200, a lane line 230 is provided at, for example, a place in adjacency to the non-roadway 300. The roadway 200 is in adjacency to an opposite lane, for example, with a centerline 220 in between.

As illustrate in FIG. 3, arrow blades 400 are disposed above the travel road surface 210 at predetermined intervals. The arrow blades 400 are a kind of a road surface shape estimation sign indicating a position of a road edge (lane line 230) of the roadway 200. That is, each arrow blade 400 is disposed at a position away from the road surface (travel road surface 210) of the roadway 200. The road edge (lane line 230) of the roadway 200 is disposed at a position directly below each arrow blade 400. Each arrow blade 400 is coupled to a support pole 410 fixed to the non-roadway 300, and is supported by the support pole 410.

FIG. 4 illustrates an example of a state in which a snowstorm or the like has caused poor visibility. As illustrated in FIG. 4, when a snowstorm or the like causes poor visibility, not only the lane line 230 and the centerline 220 but also an outline and unevenness of the roadway 200 and even the support pole 410 sometimes become invisible. At this occasion, there is possibility that, for example, the vehicle 100 deviates from the roadway 200 or falls into a groove provided on the road edge of the roadway 200.

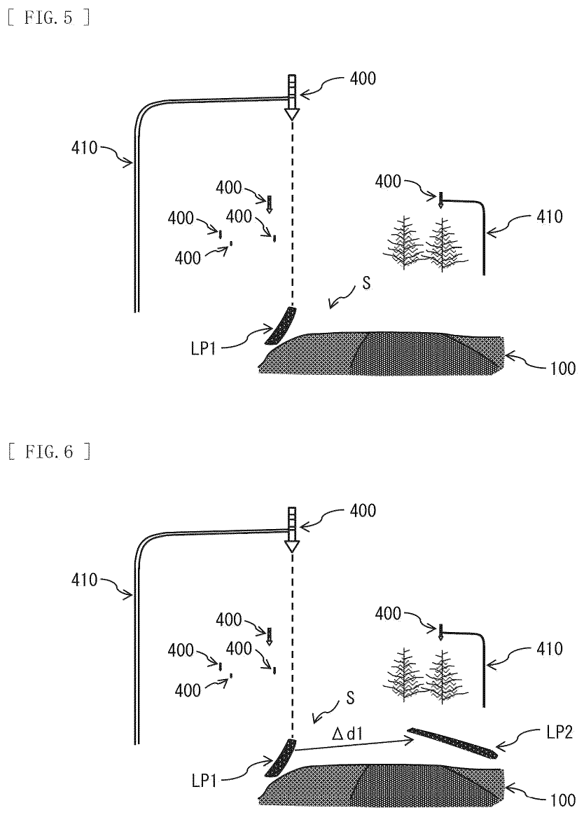

Thus, for example, as illustrated in FIG. 5, the vehicle 100 is configured to cast a straight (linear) visible laser pattern LP1 (visible laser light) on the snow surface S by using the laser irradiator 130. The visible laser pattern LP1 has a pattern corresponding to a pattern of the road edge (lane line 230) of the roadway 200. Thus, the vehicle 100 is configured to allow the driver to easily visually recognize the position of the road edge (lane line 230) of the roadway 200 by indicating the position of the road edge (lane line 230) of the roadway 200 by the visible laser pattern LP1. FIG. 5 illustrates, as an example, a state in which the visible laser pattern LP1 is casted on a position, within the snow surface S, including the position directly below the arrow blade 400. In FIG. 5, one end of the visible laser pattern LP1 is disposed at the position directly below the arrow blade 400 within the snow surface S, and the other end of the visible laser pattern LP1 is disposed near a front wheel (left wheel) of the vehicle 100 within the snow surface S.

For example, as illustrated in FIG. 6, the vehicle 100 may be configured to cast not only the straight visible laser pattern LP1 but also a visible laser pattern LP2 (visible laser light) on the snow surface S by using the laser irradiator 130. At this occasion, for example, the vehicle 100 may be configured to cast the visible laser pattern LP2 on a position shifted toward the opposite lane by a predetermined distance Δd1 from a casting position of the visible laser pattern LP1. The position shifted toward the opposite lane by the predetermined distance Δd1 from the casting position of the visible laser pattern LP1 is in the vicinity of the centerline 220.

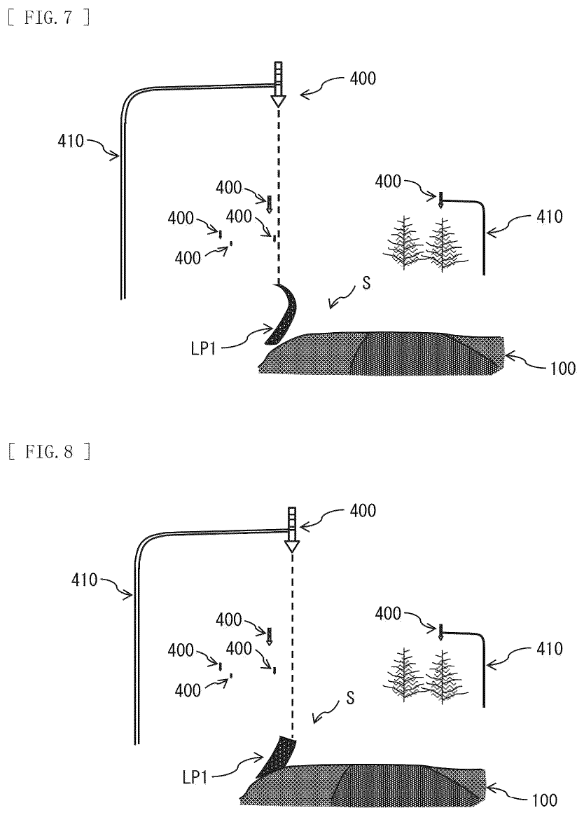

For example, as illustrated in FIG. 7, the vehicle 100 may be configured to cast a curved visible laser pattern LP1 on the snow surface S by using the laser irradiator 130. The visible laser pattern LP1 has the pattern corresponding to the pattern of the road edge (lane line 230) of the roadway 200. FIG. 7 illustrates, as an example, a state in which the visible laser pattern LP1 is casted on the position, within the snow surface S, including the position directly below the arrow blade 400. In FIG. 7, one end of the visible laser pattern LP1 is disposed at the position directly below the arrow blade 400 within the snow surface S, and the other end of the visible laser pattern LP1 is disposed near the front wheel (left wheel) of the vehicle 100 within the snow surface S.

For example, as illustrated in FIG. 8, the vehicle 100 may be configured to cast a wider visible laser pattern LP1 than the forgoing example, on the snow surface S by using the laser irradiator 130. The visible laser pattern LP1 has the pattern corresponding to the pattern of the road edge (lane line 230) of the roadway 200. FIG. 8 illustrates, as an example, a state in which the visible laser pattern LP1 is casted on the position, within the snow surface S, including the position directly below the arrow blade 400. In FIG. 8, one end of the visible laser pattern LP1 is disposed at the position directly below the arrow blade 400 within the snow surface S, and the other end of the visible laser pattern LP1 is disposed near the front wheel (left wheel) of the vehicle 100 within the snow surface S.

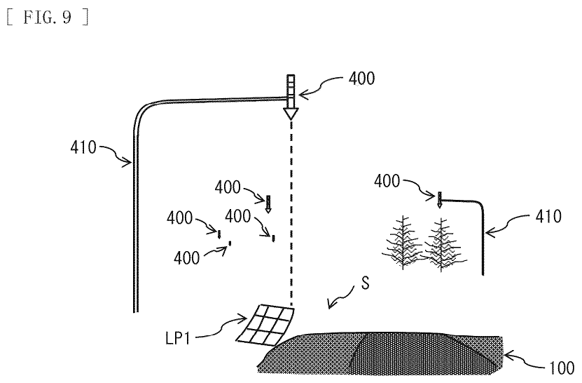

For example, as illustrated in FIG. 9, the vehicle 100 may be configured to cast a mesh-shaped visible laser pattern LP1 wider than the forgoing example, on the snow surface S by using the laser irradiator 130. The visible laser pattern LP1 has the pattern corresponding to the pattern of the road edge (lane line 230) of the roadway 200. FIG. 9 illustrates, as an example, a state in which the visible laser pattern LP1 is casted on the position, within the snow surface S, including the position directly below the arrow blade 400. In FIG. 9, one end of the visible laser pattern LP1 is disposed at the position directly below the arrow blade 400 within the snow surface S, and the other end of the visible laser pattern LP1 is disposed near the front wheel (left wheel) of the vehicle 100 within the snow surface S.

In the following, detailed description is given of a travel controller 1000 to be mounted on the vehicle 100. The travel controller 1000 is configured to cast, on the snow surface S, at least the visible laser pattern LP1 out of the visible laser pattern LP1 and the visible laser pattern LP2. The travel controller 1000 corresponds to a specific example of a “driver assistant apparatus” according to an embodiment of the disclosure. In the following, a visible laser pattern LP is used as a generic term for the visible laser pattern LP1 and the visible laser pattern LP2.

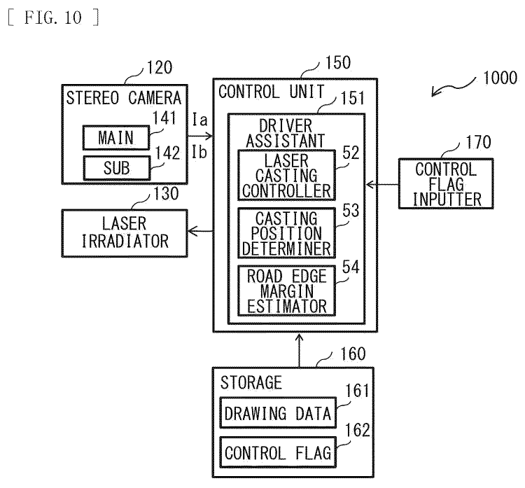

FIG. 10 illustrates an example of functional blocks of the travel controller 1000. The travel controller 1000 is configured to cast the visible laser pattern LP on the snow surface S. The travel controller 1000 includes, for example, the stereo camera 120, the laser irradiator 130, a control unit 150, a storage 160, and a control flag inputter 170. The travel controller 1000 may further include a configuration other than the configuration illustrated in FIG. 10. FIG. 10 illustrates, as an example, a configuration of a part of the travel controller 1000.

The stereo camera 120 is fixed to, for example, the upper center of the cabin CR, and includes, for example, the main camera 121 and the sub-camera 122. The main camera 121 and the sub-camera 122 are autonomous sensors that sense real space frontward of the vehicle 100. The main camera 121 and the sub-camera 122 are disposed at, for example, horizontally symmetrical positions with respect to a widthwise center portion of the vehicle 100 and capture frontward stereo images of the vehicle 100 from different viewpoints. Furthermore, for example, the stereo camera 120 is configured to output a pair of the frontward stereo images Ia of the vehicle 100 obtained by imaging with the main camera 121 and the sub-camera 122, to the control unit 150 described later. Furthermore, for example, the stereo camera 120 is configured to generate a distance image Ib based on the pair of the stereo images Ia and output the distance image Ib to the control unit 150 described later. The distance image Ib is obtained based on an amount of displacement between positions of a corresponding target.

For example, as illustrated in FIG. 1 or FIG. 2, the laser irradiator 130 is provided inside the headlights 110 or in the cabin CR. The laser irradiator 130 is configured to cast (draw) the visible laser pattern LP on the snow surface S under the control of the control unit 150.

The laser irradiator 130 includes, for example, a laser light emitting unit, a light emission control driver, an optical system, and a scanning control driver. The laser light emitting unit is configured to emit visible laser light. The light emission control driver is configured to control light emission of the laser light emitting unit. The optical system is configured to scan the laser light on the snow surface S. The scanning control driver is configured to control scanning of the laser light by the optical system. The light emission control driver is configured to control the light emission of the laser light emitting unit under the control of the control unit 150. The scanning control driver is configured to control the operation of the optical system under the control of the control unit 150. The laser light emitting unit includes, for example, a semiconductor laser that emits visible laser light. The optical system includes, for example, a polygon mirror and an fθ lens. The polygon mirror is configured to reflect visible laser light emitted from the laser light emitting unit and scan the reflected light of the visible laser light on the snow surface S through the fθ lens.

The control unit 150 is configured to control the entire vehicle 100. The control unit 150 is, for example, a so-called ECU (Electronic Control Unit), and includes, for example, one or more processors, one or more memories, and the like. The control unit 150 may include, for example, a CPU (Central Processing Unit). At this occasion, for example, the control unit 150 may be configured to control the entire vehicle 100 by, for example, executing a program held in the storage 160.

For example, as illustrated in FIG. 10, the control unit 150 includes, for example, a driver assistant 151. The driver assistant 151 is configured to assist the driver in driving the vehicle 100. For example, as illustrated in FIG. 10, the driver assistant 151 includes, for example, a laser casting controller 52, a casting position determiner 53, and a road edge margin estimator 54.

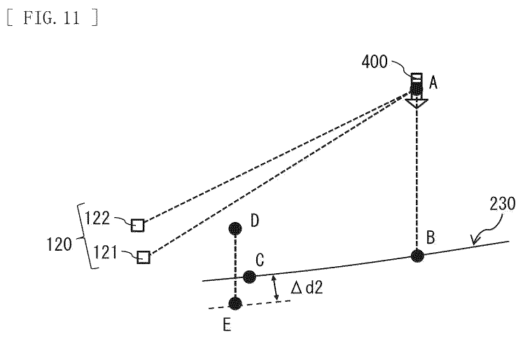

The casting position determiner 53 is configured to estimate the position (position A, FIG. 11) of the arrow blade 400 based on the distance image Ib obtained from the stereo camera 120 (sensor). For example, the casting position determiner 53 is configured to estimate the position (position A) of the arrow blade 400 based on, for example, a parallax image by the stereo camera 120. For example, the casting position determiner 53 is configured to calculate a distance from the stereo camera 120 to the arrow blade 400 based on a degree of overlap between an image obtained by the main camera 121 and an image obtained by the sub-camera 122, and calculate the position A based on the calculated distance. It is possible to calculate the distance mentioned above, for example, based on the number of pixels of the parallax image.

The casting position determiner 53 is further configured to estimate the position (position B, FIG. 11) directly below the arrow blade 400, within the road surface (travel road surface 210) of the roadway 200, based on the position (position A) of the arrow blade 400. Within the road surface (travel road surface 210) of the roadway 200, the position directly below the arrow blade 400 indicates a position of an intersection of a vertical line of the arrow blade 400 and the road surface (travel road surface 210) of the roadway 200. For example, the casting position determiner 53 is configured to estimate the position (position B) directly below the arrow blade 400, within the road surface (travel road surface 210) of the roadway 200, based on the parallax image by the stereo camera 120. For example, when a perpendicular line is drawn from the position A to the travel road surface 210 in the parallax image by the stereo camera 120, the casting position determiner 53 is configured to calculate a distance from a position (position B) where the travel road surface 210 and the perpendicular line intersect, to the position A, and calculate the position B based on the calculated distance. It is possible to calculate the distance mentioned above, for example, based on the number of pixels of the parallax image.

The casting position determiner 53 is further configured to calculate, based on the position B, the position (position C, FIG. 11) of the end, on the vehicle 100 side, of the visible laser pattern LP1 to be casted on the snow surface S. For example, the casting position determiner 53 is configured to calculate the position (position C) of the end, on the vehicle 100 side, of the visible laser pattern LP1 to be casted on the snow surface S, based on the parallax image by the stereo camera 120 and a position of attachment of the stereo camera 120. For example, the casting position determiner 53 is configured to calculate positional information (position D) regarding a part of the vehicle 100 on the non-roadway 300 side based on the parallax image by the stereo camera 120 and the position of attachment of the stereo camera 120, and set the position C based on the calculated position D. The casting position determiner 53 is configured to output the positional information (positions B and C) obtained based on the position (position A) of the arrow blade 400 to the laser casting controller 52 and the road edge margin estimator 54.

The laser casting controller 52 is configured to control casting (drawing) of the visible laser pattern LP. For example, the laser casting controller 52 is configured to generate a drawing control signal necessary for the casting (drawing) of the visible laser pattern LP based on drawing data 161 (described later) in the storage 160 and the positional information (positions B and C), and output the drawing control signal to the laser irradiator 130.

Let us assume that the drawing data 161 includes, for example, two-dimensional coordinate data regarding the straight visible laser pattern LP1. At this occasion, for example, the laser casting controller 52 is configured to correct the two-dimensional coordinate data regarding the straight visible laser pattern LP1 to allow one end of the straight visible laser pattern LP1 to take the position B and allow the other end of the straight visible laser pattern LP1 to take the position C.

Let us assume that the drawing data 161 includes, for example, two-dimensional coordinate data regarding the curved visible laser pattern LP1. At this occasion, for example, the laser casting controller 52 is configured to correct the two-dimensional coordinate data regarding the curved visible laser pattern LP1 to allow one end of the curved visible laser pattern LP1 to take the position B and allow the other end of the curved visible laser pattern LP1 to take the position C.

Let us assume that the drawing data 161 includes, for example, two-dimensional coordinate data regarding the visible laser patterns LP1 and LP2. At this occasion, for example, the laser casting controller 52 is configured to correct the two-dimensional coordinate data regarding the visible laser pattern LP2 to allow a position of the visible laser pattern LP2 to take a position shifted toward the opposite lane by the predetermined distance Δd1 from the casting position of the visible laser pattern LP1.

Let us assume that a risk flag has not been inputted to the laser casting controller 52 from the road edge margin estimator 54. At this occasion, for example, the laser casting controller 52 is configured to refrain from correcting data related to a width of the visible laser pattern LP1 in the two-dimensional coordinate data regarding the visible laser pattern LP1. When the risk flag has not been inputted to the laser casting controller 52 from the road edge margin estimator 54, the laser casting controller 52 is further configured to generate, for example, a color control signal that sets an emission color of the visible laser pattern LP1 to a color (e.g., green) indicating that a risk level is low, and output the color control signal to the laser irradiator 130.

Let us assume that the risk flag has been inputted to the laser casting controller 52 from the road edge margin estimator 54. At this occasion, for example, the laser casting controller 52 is configured to correct the two-dimensional coordinate data regarding the visible laser pattern LP1 to allow, for example, the width of the visible laser pattern LP1 to become a width corresponding to the risk flag. For example, the laser casting controller 52 is further configured to generate the color control signal that sets the emission color of the visible laser pattern LP1 to a color corresponding to the risk flag and output the color control signal to the laser irradiator 130.

When the risk flag is, for example, a flag indicating that the risk level is intermediate, the laser casting controller 52 is configured to correct the two-dimensional coordinate data regarding the visible laser pattern LP1 to allow, for example, the width of the visible laser pattern LP1 to be twice as large as usual. When the risk flag is, for example, the flag indicating that the risk level is intermediate, the laser casting controller 52 is further configured to generate, for example, the color control signal that sets the emission color of the visible laser pattern LP1 to a color (e.g., yellow) indicating that the risk level is intermediate, and output the color control signal to the laser irradiator 130.

When the risk flag is, for example, a flag indicating that the risk level is high, the laser casting controller 52 is configured to correct the two-dimensional coordinate data regarding the visible laser pattern LP1 to allow, for example, the width of the visible laser pattern LP1 to be three times as large as usual. When the risk flag is, for example, the flag indicating that the risk level is high, the laser casting controller 52 is further configured to generate, for example, the color control signal that sets the emission color of the visible laser pattern LP1 to a color (e.g., red) indicating that the risk level is high, and output the color control signal to the laser irradiator 130.

For example, as illustrated in FIG. 11, the road edge margin estimator 54 is configured to estimate a distance (road end margin Δd2) from the vehicle 100 to the road edge of the roadway 200. For example, as illustrated in FIG. 11, the road edge margin estimator 54 is configured to estimate the distance (road edge margin Δd2) from the vehicle 100 to the road edge of the roadway 200 based on the positional information (positions B and C) inputted from the casting position determiner 53 and the positional information (position D) regarding a part of the vehicle 100 on the non-roadway 300 side. The position D is, for example, the positional information regarding a spot of the vehicle 100 captured in the stereo image Ia. For example, as illustrated in FIG. 11, the road edge margin estimator 54 is configured to estimate, based on the position D, a position (position E, FIG. 11) directly below the position D within the road surface (travel road surface 210) of the roadway 200. The road edge margin estimator 54 is configured to estimate the road edge margin Δd2 based on, for example, the position B, the position C, and the position E.

The road edge margin estimator 54 is configured to determine a risk of the vehicle 100 deviating from the road edge of the roadway 200 based on the road edge margin Δd2 obtained by the estimation. For example, when the road edge margin Δd2 is equal to or larger than a threshold th1, the road edge margin estimator 54 is configured to determine that the risk of the vehicle 100 deviating from the road edge of the roadway 200 is low, and refrain from generating the risk flag.

For example, when the road edge margin Δd2 is equal to or larger than a threshold th2 and smaller than the threshold th1, the road edge margin estimator 54 is configured to determine that the risk of the vehicle 100 deviating from the road edge of the roadway 200 is relatively high, generate, as the risk flag, the flag indicating that the risk level is intermediate, and output the flag to the laser casting controller 52. For example, when the road end margin Δd2 is smaller than a threshold th3, the road edge margin estimator 54 is configured to determine that the risk of the vehicle 100 deviating from the road edge of the roadway 200 is very high, generate, as the risk flag, the flag indicating that the risk level is high, and output the flag to the laser casting controller 52.

In a case where the road edge margin estimator 54 has calculated the distance (road edge margin Δd2) from the lane line 230 to a tire edge when there is no snow accumulation on the road surface, and stored the distance in the storage 160, the road edge margin estimator 54 may be configured to set the position C based on the position B and the road edge margin Δd2 read out from the storage 160.

The road edge margin estimator 54 may be configured to estimate positional relation between the vehicle 100 and the road edge of the roadway 200 instead of the distance (road edge margin Δd2) from the vehicle 100 to the road edge of the roadway 200. Examples of the positional relation include positional relation between a structure on the road edge of the roadway 200 and the end of the vehicle 100 on the non-roadway 300 side. At this occasion, the road edge margin estimator 54 may be configured to determine the risk of the vehicle 100 deviating from the road edge of the roadway 200, based on the positional relation between the vehicle 100 and the road edge of the roadway 200.

The storage 160 holds, for example, the drawing data 161 necessary for drawing at least the visible laser pattern LP1 out of the visible laser patterns LP1 and LP2. The drawing data 161 includes, for example, the two-dimensional coordinate data regarding at least the visible laser pattern LP1 out of the visible laser patterns LP1 and LP2. The storage 160 further holds, for example, a control flag 162 inputted from the control flag inputter 170. The storage 160 may hold, for example, a program to be executed by the control unit 150. This program is a program that causes the control unit 150 to execute a series of procedures to control the entire vehicle 100. The storage 160 includes, for example, a RAM (Random Access Memory), a ROM (Read Only Memory), and a secondary storage device (such as a hard disk).

The control flag inputter 170 is configured to accept an input of the control flag 162 from the driver. The control flag inputter 170 is, for example, paddle shifts added to a steering wheel. For example, when the right and left paddle shifts are simultaneously long pressed by the driver, the control flag inputter 170 is configured to store “1” as the control flag 162 in the storage 160. For example, after “1” is stored as the control flag 162 in the storage 160 last time, when the right and left paddle shifts are simultaneously long pressed again by the driver, the control flag inputter 170 is configured to store “0” as the control flag 162 in the storage 160. For example, after “0” is stored as the control flag 162 in the storage 160 last time, when the right and left paddle shifts are simultaneously long pressed again by the driver, the control flag inputter 170 is configured to store “1” as the control flag 162 in the storage 160.

When the control flag 162 is “1”, the control flag 162 means, for example, a laser casting mode. When the control flag 162 is “0”, the control flag 162 means, for example, a normal mode in which the laser casting is not performed automatically. It is to be noted that the values the control flag 162 possibly takes are not limited to the forgoing.

### Operation

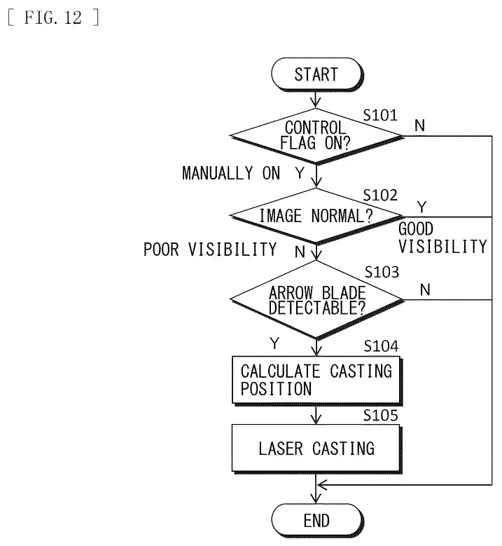

Next, with reference to FIG. 12, operation of the travel controller 1000 is described. FIG. 12 is a diagram for description of an example of a procedure of casting the visible laser pattern in the travel controller 1000.

The driver assistant 151 reads out the control flag 162 from the storage 160, and determines whether the read control flag 162 is on (“1”) (step S101). When the control flag 162 is on (“1”) (step S101; Y), the driver assistant 151 determines presence or absence of any abnormality in the stereo image Ia obtained from the stereo camera 120 (step S102).

In step S102, the driver assistant 151 determines, for example, whether the scenery frontward of the vehicle 100 included in the stereo image Ia has poor visibility (e.g., white out, etc.) because of a snowstorm. As a result, when the scenery frontward of the vehicle 100 included in the stereo image Ia has poor visibility because of a snowstorm (step S102; N), the driver assistant 151 determines whether the arrow blade 400 is detectable in the stereo image Ia (step S103). As a result, when the arrow blade 400 is detectable in the stereo image Ia (step S103; Y), the driver assistant 151 calculates the casting position of at least the visible laser pattern LP1 out of the visible laser patterns LP1 and LP2 (step S104). Based on the casting position obtained by the calculation, the driver assistant 151 casts at least the visible laser pattern LP1 out of the visible laser patterns LP1 and LP2 on the snow surface S (step S105).

At this occasion, for example, as illustrated in FIG. 5, the driver assistant 151 casts the straight (linear) visible laser pattern LP1 on the snow surface S. For example, as illustrated in FIG. 6, the driver assistant 151 casts not only the straight visible laser pattern LP1 but also the straight visible laser pattern LP2 on the snow surface S. For example, as illustrated in FIG. 7, the driver assistant 151 casts the curved visible laser pattern LP1 on the snow surface S. For example, as illustrated in FIG. 8, the driver assistant 151 casts, on the snow surface S, the visible laser pattern LP1 having the width corresponding to the risk flag. For example, the driver assistant 151 casts, on the snow surface S, the visible laser pattern LP1 of the color corresponding to the risk flag. For example, as illustrated in FIG. 9, the driver assistant 151 casts the mesh-shaped visible laser pattern LP1 on the snow surface S. In this way, the casting of the visible laser pattern LP is performed in the travel controller 1000.

When the control flag 162 is off (“0”) (step S101; N), when the scenery frontward of the vehicles 100 included in the stereo image Ia has good visibility (step S102; Y), or when the arrow blade 400 is undetectable in the stereo image Ia (step S103; N), the driver assistant 151 refrains from performing the laser casting.

### Effects

Next, effects of the vehicle 100 according to the embodiment are described.

In the embodiment, the casting position on the travel road surface 210 (or snow surface S) is derived based on the position of the arrow blade 400. The arrow blade 400 is a kind of the road surface shape estimation sign disposed at the position away from the road surface (the travel road surface 210) of the roadway 200. The position of the arrow blade 400 is detected by the sensor (stereo camera 120). Moreover, the casting of the visible laser pattern LP is controlled based on the derived casting position. Thus, even on travel in a snowstorm, it is possible for the driver to travel on the roadway (travel lane) 200 by following the visible laser pattern LP. As a result, it is possible to prevent the vehicle from, for example, deviating from the roadway (travel lane) or falling into a groove provided on the road edge of the roadway (travel lane) during manual driving. Hence, it is possible to drive safely in a snowstorm during manual driving.

In the embodiment, as the visible laser pattern LP, the straight (linear) or mesh-shaped visible laser light may be casted on the snow surface S. In such a case, it is possible for the driver to travel on the roadway (travel lane) 200 by following the visible laser pattern LP. As a result, it is possible to prevent the vehicle from, for example, deviating from the roadway (travel lane) or falling into a groove provided on the road edge of the roadway (travel lane) during manual driving. Hence, it is possible to drive safely in a snowstorm during manual driving.

In the embodiment, one or more of a casting shape, a casting range, and a casting color of the visible laser pattern LP may be controlled based on positional relation between the casting position and the vehicle 100 or magnitude of a distance from the casting position to the vehicle 100. The casting range is a concept including, for example, whether to cast only the visible laser pattern LP1 or whether to cast the visible laser pattern LP2 as well. In such a case, it is possible to enhance visibility of the visible laser pattern LP to the driver, or notify the driver of any risk.

### 3. Modification Examples

Although the disclosure has been described with reference to the embodiments, the disclosure is not limited to the embodiments, and various modifications may be made.

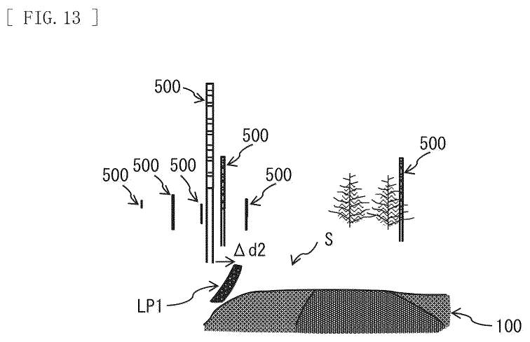

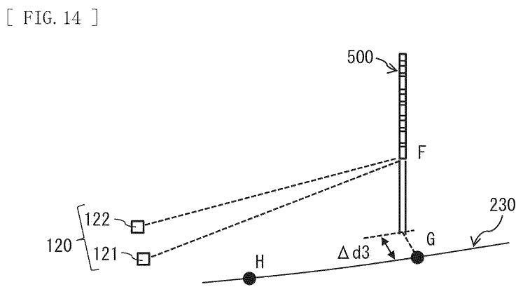

In the forgoing embodiment, instead of the arrow blade 400, for example, as illustrated in FIG. 13, snow poles 500 may be disposed at positions away from the road surface (travel road surface 210) of the roadway 200. The snow poles 500 are a kind of the road surface shape estimation sign indicating the position of the road edge (lane line 230) of the roadway 200. Each of the snow poles 500 is disposed on, for example, a roadside, a road shoulder, or a sidewalk, and is fixed at a position away from the road edge (lane line 230) of the roadway 200 by a predetermined distance.

The casting position determiner 53 is configured to estimate a position (position F, FIG. 14) of the snow pole 500 based on the distance image Ib obtained from the stereo camera 120. For example, the casting position determiner 53 is configured to estimate the position (position F) of the snow pole 500 based on the parallax image by the stereo camera 120. For example, the casting position determiner 53 is configured to calculate a distance from the stereo camera 120 to the arrow blade 400 based on the degree of overlap between the image obtained by the main camera 121 and the image obtained by the sub-camera 122, and calculate the position F based on the calculated distance. It is possible to calculate the distance mentioned above based on, for example, the number of pixels of the parallax image.

The casting position determiner 53 is further configured to estimate the position (position G, FIG. 14) of the road edge (lane line 230) of the roadway 200 based on the position (position F) of the snow pole 500. For example, the casting position determiner 53 is configured to assume a position shifted toward the roadway 200 by a predetermined distance Δd3 from a spot estimated as a grounding point of the snow pole 500, as the position (position G) of the road edge (lane line 230) of the roadway 200.

The casting position determiner 53 is further configured to calculate, based on the position G, a position (position H, FIG. 14) of the end, on the vehicle 100 side, of the visible laser pattern LP1 to be casted on the snow surface S. For example, the casting position determiner 53 is configured to calculate the position (position H) of the end, on the vehicle 100 side, of the visible laser pattern LP1 to be casted on the snow surface S, based on the parallax image by the stereo camera 120 and the position of attachment of the stereo camera 120. The casting position determiner 53 is configured to output positional information (positions G and H) obtained based on the position (position F) of the arrow blade 400 to the laser casting controller 52 and the road edge margin estimator 54.

In this modification example, the casting position on the travel road surface 210 (or snow surface S) is derived based on the position of the snow pole 500 as a kind of the road surface shape estimation sign disposed at the position away from the road surface (travel road surface 210) of the roadway 200. The position of the snow pole 500 is detected by the sensor (stereo camera 120). Moreover, the casting of the visible laser pattern LP is controlled based on the derived casting position. Thus, even on travel in a snowstorm, it is possible for the driver to travel on the roadway (travel lane) 200 by following the visible laser pattern LP. As a result, it is possible to prevent the vehicle from, for example, deviating from the roadway (travel lane) or falling into a groove provided on the road edge of the roadway (travel lane) during manual driving. Hence, it is possible to drive safely in a snowstorm during manual driving.

Although the disclosure has been described in the foregoing by giving the embodiments, the disclosure is by no means limited to such embodiments. It should be appreciated that various modifications and alterations may be made. The effects described in the specification are merely examples. Effects of the disclosure are not limiting to the effects described in the specification. Accordingly, other effects with respect to the disclosure may be produced.

Furthermore, the disclosure may take the following configurations.
(1)

A driver assistant apparatus including a controller configured to provide driver assistance,
the controller is configured to:
   derive, based on a position of a road surface shape estimation sign disposed at a position away from a road surface of a roadway, a casting position on the road surface, the position of the road surface shape estimation sign being detected by a sensor; and
   control casting of visible laser light based on the derived casting position.
(2)

The driver assistant apparatus according to (1), in which
the road surface shape estimation sign includes an arrow blade disposed above the road surface, and
the controller is configured to assume, as the casting position, a linear position including an intersection of a vertical line of the arrow blade and the road surface.
(3)

The driver assistant apparatus according to (1), in which
the road surface shape estimation sign includes a snow pole disposed on a roadside, a road shoulder, or a sidewalk, and
the controller is configured to assume, as the casting position, a linear position including a spot shifted toward the roadway by a predetermined distance from an estimated spot as a grounding point of the snow pole.
(4)

The driver assistant apparatus according to any one of (1) to (3), in which
the controller is configured to control the casting of the visible laser light to cast linear or mesh-shaped light.
(5)

The driver assistant apparatus according to any one of (1) to (4), in which
the controller is configured to control one or more of a casting shape, a casting range, and a casting color of the visible laser light, based on positional relation between the casting position and a vehicle to which the driver assistance is provided by the driver assistant apparatus, or magnitude of a distance from the casting position to the vehicle to which the driver assistance is provided by the driver assistant apparatus.
(6)

A vehicle including a controller configured to provide driver assistance,
the controller is configured to:
   derive, based on a position of a road surface shape estimation sign disposed at a position away from a road surface of a roadway, a casting position on the road surface, the position of the road surface shape estimation sign being detected by a sensor; and
   control casting of visible laser light based on the derived casting position.
(7)

A driver assistance method including:
deriving, based on a position of a road surface shape estimation sign disposed at a position away from a road surface, a casting position on the road surface, the position of the road surface shape estimation sign being detected by a sensor; and
casting visible laser light based on the derived casting position.

The control unit 150 illustrated in FIG. 10 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one non-transitory tangible computer-readable medium, to perform all or a part of various functions of the control unit 150 illustrated in FIG. 10. Such a medium may take various forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM. The nonvolatile memory may include a ROM and a NVRAM. The ASIC is an integrated circuit (IC) customized to perform, and the FPGA is an integrated circuit designed to be configured after manufacturing in order to perform, all or a part of the various functions of the control unit 150 illustrated in FIG. 10.

1. A driver assistant apparatus comprising a controller configured to provide driver assistance,
the controller is configured to:
derive, based on a position of a road surface shape estimation sign disposed at a position away from a road surface of a roadway, a casting position on the road surface, the position of the road surface shape estimation sign being detected by a sensor; and
control casting of visible laser light based on the derived casting position.

2. The driver assistant apparatus according to claim 1, wherein
the road surface shape estimation sign comprises an arrow blade disposed above the road surface, and
the controller is configured to assume, as the casting position, a linear position including an intersection of a vertical line of the arrow blade and the road surface.

3. The driver assistant apparatus according to claim 1, wherein
the road surface shape estimation sign comprises a snow pole disposed on a roadside, a road shoulder, or a sidewalk, and
the controller is configured to assume, as the casting position, a linear position including a spot shifted toward the roadway by a predetermined distance from an estimated spot as a grounding point of the snow pole.

4. The driver assistant apparatus according to claim 1, wherein
the controller is configured to control the casting of the visible laser light to cast linear or mesh-shaped light.

5. The driver assistant apparatus according to claim 1, wherein
the controller is configured to control one or more of a casting shape, a casting range, and a casting color of the visible laser light, based on positional relation between the casting position and a vehicle to which the driver assistance is provided by the driver assistant apparatus, or magnitude of a distance from the casting position to the vehicle to which the driver assistance is provided by the driver assistant apparatus.

6. A vehicle comprising a controller configured to provide driver assistance,
the controller is configured to:
derive, based on a position of a road surface shape estimation sign disposed at a position away from a road surface of a roadway, a casting position on the road surface, the position of the road surface shape estimation sign being detected by a sensor; and
control casting of visible laser light based on the derived casting position.

7. A driver assistance method comprising:
deriving, based on a position of a road surface shape estimation sign disposed at a position away from a road surface, a casting position on the road surface, the position of the road surface shape estimation sign being detected by a sensor; and
casting visible laser light based on the derived casting position.
